(19) United States
(12) Patent Application Publication
(10) Pub. No.: US 2006/0231750 A1
(43) Pub. Date: Oct. 19, 2006

(54) Image sensor module package

(75) Inventors: Yeong-Ching Chao, Tainan (TW); An-Hong Liu, Tainan (TW); Hsiang-Ming Huang, Tainan (TW); Yi-Chang Lee, Tainan (TW); Yao-Jung Lee, Tainan (TW)

Correspondence Address: TROXELL LAW OFFICE PLLC;SUITE 1404, 5205 LEESBURG PIKE, FALLS CHURCH, VA, 22041, US

(73) Assignees: ChipMOS TECHNOLOGIES (Bermuda) LTD.; ChipMOS TECHNOLOGIES INC.

(21) Appl. No.: 11/364,324

(22) Filed: Mar. 1, 2006

(30) Foreign Application Priority Data
Apr. 14, 2005 (CN) 094111882

(51) Int. Cl. H01J 5/02

(52) U.S. Cl. 250/239

(57) ABSTRACT

An image sensor module package is disclosed. A plurality of connecting pads are formed on a first surface of a glass substrate having and located outside a light entering area. A via-redistribution layer is formed on an opposing second surface of the glass substrate. A plurality of vias penetrate the glass substrate to electrically connect the via-redistribution layer with the connecting pads. A bumped image sensor chip is flip-chip attached to the second surface of the glass substrate so that a sensing area of the image sensor chip is corresponding to a light entering area of the glass substrate without blocking the via-redistribution layer. The connecting pads may connect to a plurality of solder balls or a FPC. In one embodiment, a plurality of passive components can be placed on the via-redistribution layer to enhance the electrical performance and the functions of the image sensor module package.

### FIELD OF THE INVENTION

The present invention relates to an image sensor module package, and more particularly, to an image sensor module package by flip-chip attaching an image sensor chip to a glass substrate.

### BACKGROUND OF THE INVENTION

Image sensor devices have been widely implemented in everyday lives such as cellular phones, personal digital assistants (PDA), digital still cameras (DSC), digital video cameras (DV), video phones, video conferences, and so on. In order to meet the needs of the consumers, there are more requirements for image qualities and functions.

One kind of image sensor package is COG (Chip-On-Glass) type. As shown in FIG. 1, a conventional image sensor package 100 comprises a glass substrate 110, a bumped image sensor chip 120, an encapsulant 130 and a plurality of solder balls 140. The glass substrate 110 has a first surface 111 and a second surface 112 where the first surface 111 has a light entering area 113. Moreover, the glass substrate 110 has a plurality of bump pads 114, a wiring layer 115, a plurality of vias 116, and a plurality of ball pads 117 where the ball pads 117 and the wiring layer 115 are formed on the first surface 111 of the glass substrate 110. The bump pads 114 are formed on the second surface 112 of the glass substrate 110. The wiring layer 115 is connected to the ball pads 117 located in the light entering area 113. The vias 116 are aligned with the fine-pitch bump pads 114 and electrically connected to the wiring layer 115. The image sensor chip 120 having an sensor area 121 is flip-chip attached to the second surface 112 of the substrate 110 so that the sensor area 121 is aligned with the light entering area 113 and the image sensor chip 120 is electrically connected to the bump pads 114 via a plurality of bumps 122. Furthermore, the solder balls 140 are placed on the ball pads 117.

In this image sensor package 100, since the wiring layer 115 extends to the light entering area 115 in fan-in configuration and the ball pads 117 are located adjacent to the light entering area 113, light distortion and interference becomes an issue. Furthermore, the glass substrate 110 doesn't have enough space for placing passive components so that the image sensor package 100 cannot have a better electrical performance. A wafer-level image sensor package revealed in U.S. Pat. No. 6,342,406 is quite similar to the disclosed image sensor package 100 as shown in FIG. 1.

### SUMMARY OF THE INVENTION

The main purpose of the present invention is to provide an image sensor module package. A bumped image sensor chip is flip-chip attached to a glass substrate. The glass substrate includes a plurality of connecting pads, a via-redistribution layer, a plurality of vias, where the connecting pads are formed on a first surface of the glass substrate and located outside a light entering area. The via-redistribution layer is formed on a second surface of the glass substrate to redistribute the locations of the vias with a larger pitch. Through the vias in the glass substrate, the connecting pads are electrically connected to the via-redistribution layer. When flip-chip attaching, the image sensor chip is disposed on the second surface and is electrically connected to the via-redistribution layer to enhance the electrical performance of the image sensor module package.

The second purpose of the present invention is to provide an image sensor module package. An image sensor chip is flip-chip attached to a glass substrate where the glass substrate includes a plurality of connecting pads, a via-redistribution layer, and a plurality of vias. The via-redistribution layer with a fan-out design is configured for bonding the image sensor chip by a plurality of bumps and is electrically connected to the connecting pads by the vias so that the image sensor module package can offer enough spaces for passive components without light distortion nor interference.

According to the present invention, an image sensor module package comprises a glass substrate and a bumped image sensor chip where the glass substrate has a first surface and an opposing second surface. The glass substrate includes a plurality of connecting pads on the first surface, a via-redistribution layer on the second surface, and a plurality of vias through the first surface and the second surface. A light entering area is defined in the first surface. The connecting pads are located outside the light entering area. The via-redistribution layer connects the plurality of vias with a fan-out design and thereby is electrically connected to the connecting pads. The image sensor chip is flip-chip attached to the second surface of the glass substrate where the image sensor chip has a sensing area and a plurality of bumps. The sensing area is aligned with the light entering area of the glass substrate. The image sensor chip is bonded to the via-redistribution layer of the glass substrate via the bumps.

### DESCRIPTION OF THE DRAWINGS

FIG. 1 is a cross-sectional view of a conventional image sensor package.

FIG. 2 is a cross-sectional view of an image sensor module package according to the first embodiment of the present invention.

FIG. 3 is a cross-sectional view of an image sensor module package according to the second embodiment of the present invention.

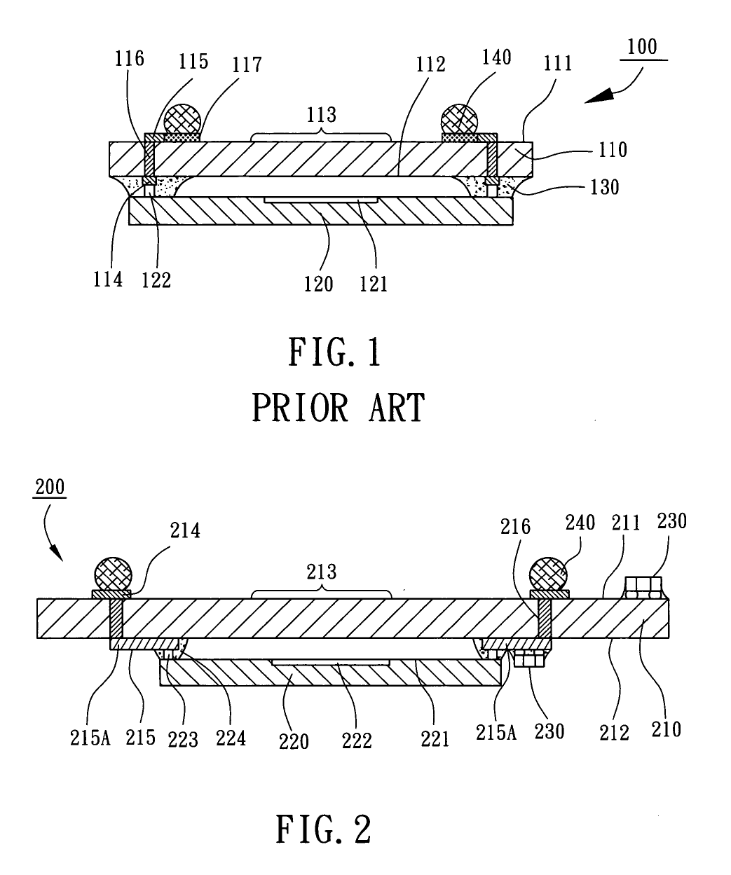

### DETAIL DESCRIPTION OF THE INVENTION

Please refer to the attached drawings, the present invention will be described by means of embodiment(s) below.

According to the first embodiment of the present invention, as shown in FIG. 2, an image sensor module package 200 comprises a glass substrate 210, a bumped image sensor chip 220, and a plurality of passive components 230 where the glass substrate 210 has a first surface 211 and an opposing second surface 212. A light entering area 213 is defined in the first surface 211. Moreover, the glass substrate 210 includes a plurality of connecting pads 214, a via-redistribution layer 215, and a plurality of vias 216 where the connecting pads 214 are formed on the first surface 211 of the glass substrate 210 and located outside the light entering area 213. The via-redistribution layer 215 is formed on the second surface 212 without blocking the light entering area 213 where the via-redistribution layer 215 has a plurality of fan-out pads 215A connected with traces in a fan-out design to redistribute the locations of the vias 216 with a larger pitch. The vias 216 are formed in the glass substrate 210 penetrating through the first surface 211 and the second surface 212 and are aligned with the corresponding fan-out pads 215A. Furthermore, the vias 216 electrically connect the connecting pads 214 with the via-redistribution layer 215. In one embodiment, each of the vias 216 is located between each of the fan-out pads 215A and each of the connecting pads 214.

The bumped image sensor chip 220 is flip-chip attached to the second surface 212 of the glass substrate 210 where the image sensor chip 220 has an active surface 221 with a sensing area 222 and a plurality of bumps 223 formed on the active surface 221. The sensing area 222 is aligned with the light entering area 213 of the glass substrate 210. The image sensor chip 220 is bonded to the via-redistribution layer 215 on the glass substrate 210 by the bumps 223. The bumps 223 are Au plating bumps, Au stud bumps or the other conductive bumps. An encapsulant 224 is used to seal the bumps 223 where the encapsulant 224 is chosen from anisotropic conductive paste (ACP), non-conductive paste (NCP), underfill material, photocurable paste, and B-stage film etc. Accordingly, the via-redistribution layer 215 does not block the sensing area 222. In the present embodiment, the image sensor chip 220 is a CMOS image sensor chip. The passive components 230 may be disposed on the first surface 211 or on the second surface 212 of the glass substrate 210 and are electrically connected to the via-redistribution layer 215. In this embodiment, the image sensor module package 200 further comprises a plurality of solder balls 240 placed on the connecting pads 214 of the glass substrate 210 to external interconnection to other electronic devices.

Since the via-redistribution layer 215 on the glass substrate 210 is a fan-out design, so that the pitch of the vias 216 is larger than the pitch of the bumps 223. More of the passive components 230 can be placed on the via-redistribution layer 215 to enhance electrical performance. Moreover, electrical interference can be avoided. Furthermore, the connecting pads 214 are located outside the light entering area 213 so that light distortion and interference can be also avoided.

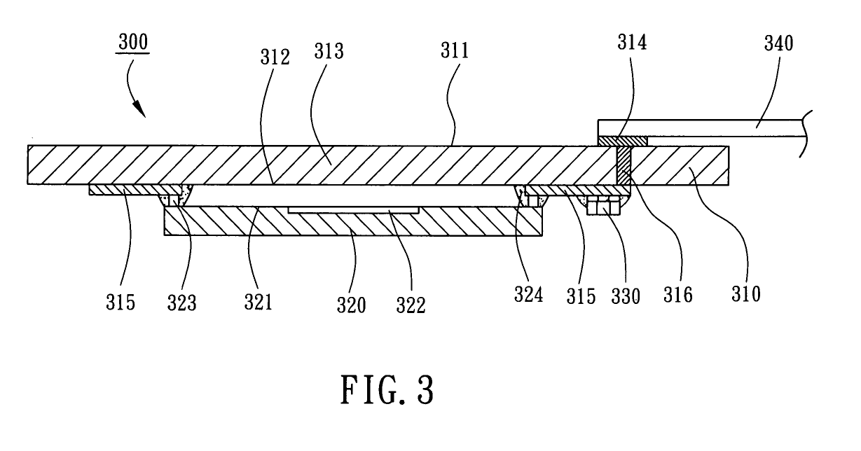

According to the second embodiment of the present invention, as shown in FIG. 3, an image sensor module package 300 comprises a glass substrate 310, a bumped image sensor chip 320, a plurality of passive components 330, and a flexible printed circuit 340 (FPC) where the glass substrate 310 has a first surface 311 and an opposing second surface 312. A light entering area 313 is defined on the first surface 311. The glass substrate 310 includes a plurality of connecting pads 314, a via-redistribution layer 315, and a plurality of vias 316 where the connecting pads 314 are formed on the first surface 311 and located outside the light entering area 313 of the glass substrate 310. The connecting pads 314 are formed on the second surface-312 and electrically connected to the via-redistribution layer 315 through the vias 316.

The bumped image sensor chip 320 is flip-chip attached to the second surface 312 of the glass substrate 310. The image sensor chip 320 has an active surface 321 which includes a sensing area 322. A plurality of bumps 323 are formed on the active surface 321 and are electrically connected the image sensor chip 320 to the via-redistribution layer 315. The sensing area 322 is aligned with the light entering area 313 on the first surface 311. An encapsulant 324 is used to seal the bumps 323. Preferably, the via-redistribution layer 315 is a fan-out design from the bumps 323. The passive components 330 are disposed on the second surface 312 of the glass substrate 310 to enhance the electrical performance of the image sensor chip 320. In this embodiment, the FPC 340 is bonded to the connecting pads 314 to transmit the signals of the image sensor chip 320.

Since the via-redistribution layer 315 is fan-out from the bumps 323 of the image sensor chip 320, the vias 316 have enough pitches to be formed in the glass substrate 310 by laser drilling. Moreover, the via-redistribution layer 315 is electrically connected to the connecting pads 314 through the vias 316, therefore, the via-redistribution layer 315 will have more space to place passive components 330 on the second surface 312 of the glass substrate 310 and the image sensor module package 300 will not have the electrical interference due to the passive components 330. Furthermore, when connecting the FPC 340, the connecting pads 314 are formed on one side of the light entering area 313 so that connecting pads 314 can have wider spacing to electrically connect to the FPC 340 to avoid electrical interference due to smaller spacing of the connecting pads 314.

The above description of embodiments of this invention is intended to be illustrative and not limiting. Other embodiments of this invention will be obvious to those skilled in the art in view of the above disclosure.

What is claimed is:

1. An image sensor module package comprising:
a glass substrate having a first surface and an opposing second surface, wherein a light entering area is defined in the first surface, the glass substrate including:
a plurality of connecting pads formed on the first surface and outside the light entering area;
a via-redistribution layer formed on the second surface and has a plurality of fan-out pads; and
a plurality of vias penetrating the glass substrate and aligning with the fan-out pads and electrically connecting to the connecting pads; and
a bumped image sensor chip flip-chip attached to the second surface of the glass substrate, wherein the image sensor chip has an active surface with a sensing area and a plurality of bumps, wherein the sensing area is aligned with the light entering area and the image sensor chip is electrically connected to the via-redistribution layer through the bumps.

2. The image sensor module package of claim 1, further comprising a plurality of passive components placed on the second surface of the glass substrate and electrically connected to the via-redistribution layer.

3. The image sensor module package of claim 1, further comprising a plurality of passive components placed on the first surface of the glass substrate.

4. The image sensor module package of claim 1, wherein the via-redistribution layer is located outside the light entering area without blocking the sensing area of the image sensor chip.

5. The image sensor module package of claim 1, wherein the vias are formed on the peripheries of the glass substrate.

6. The image sensor module package of claim 1, further comprising a plurality of electrically connecting components placed on the connecting pads.

7. The image sensor module package of claim 6, wherein the electrically connecting components are solder balls.

8. The image sensor module package of claim 1, further comprising a flexible printed circuit board electrically connecting to the connecting pads.

9. The image sensor module package of claim 1, further comprising an encapsulant formed between the glass substrate and the image sensor chip to seal the bumps.

10. The image sensor module package of claim 1, wherein each of the vias is located between each of the fan-out pads and each of the connecting pads.

11. The image sensor module package of claim 1, wherein the pitch of the vias is larger than the pitch of the bumps.
